(19) United States
(12) Patent Application Publication
(10) Pub. No.: US 2017/0267554 A1
(43) Pub. Date: Sep. 21, 2017

(54) METHOD AND APPARATUS FOR ELECTROCOAGULATION

(71) Applicant: Teftech Limited, Dorset (GB)

(72) Inventor: Christopher Michael David Joslin, Dorset (GB)

(73) Assignee: Teftech Limited, Dorset (GB)

(21) Appl. No.: 15/532,135

(22) PCT Filed: Oct. 21, 2015
(86) PCT No.: PCT/GB2015/053143

§ 371 Date: Jun. 1, 2017

(30) Foreign Application Priority Data
Dec. 9, 2014 (GB) 1421878.8
Aug. 5, 2015 (GB) 1513866.2

(51) Int. Cl. C02F 1/48

(52) U.S. Cl. CPC C02F 1/48; C02F 2201/48; C02F 2303/08

(57) ABSTRACT

A method and apparatus is described that uses a device that presents a surface of a dielectric material to a flowing or circulating fluid that results in charge being created at a boundary layer of the dielectric where it contacts the fluid by ion exchange and charging of compounds, for example insoluble dielectric particles such as colloids, and using at least one control impedance to control an impressed current in the fluid caused by the fluid flowing through the device and to cause suspended particles in the fluid to be charged, whereby the charge of the suspended particles is then neutralised causing coagulation of the particles as suspended insoluble particles.

### BACKGROUND

This invention relates to the removal of suspended material from flowing fluids by electrocoagulation.

Various electrocoagulation techniques using external power sources have been used to rid water of unwanted suspended matter. In effluents such as water treated by sewerage purification plants and destined to be used for human consumption, contaminants in the form of suspended particles which are too small to remove by filtration are flocculated by the process into larger filterable particles which aggregate so that their removal by settling and decanting can be effected. Electrocoagulation can be used to remove compounds suspended in water which may be too valuable to lose or which might constitute an environmental hazard. Heavy metals for instance are extremely harmful. Valuable metals such as aluminium compounds can be removed from waste water effluent arising from manufacturing pure aluminium from the mineral bauxite.

Chemicals have been used as coagulants, sometimes with serious results. In Cornwall, U.K., aluminium sulphate was being used to precipitate suspended material from the public water supply and was accidentally used to excess causing a health risk to water supply customers.

Chemical coagulation, whereby polymers are added to the water to be treated has been used for decades but the addition of chemicals tends to increase the Total dissolved Solids (T.D.S.) content of the water making it unfit for immediate re-use.

Chemical treatment methods can enable the removal of suspended metal oxides, colloidal solids and particles, and soluble inorganic pollutants from aqueous media by introducing highly charged polymeric metal hydroxide species. These species neutralize the electrostatic charges on suspended solids and oil droplets to facilitate agglomeration or coagulation and resultant separation from the aqueous phase. Chemical treatment prompts the precipitation of certain metals and salts but can complicate the problems by adding further reactions and materials to the fluid.

Electrocoagulation offers an alternative to the use of metal salts or polymers and polyelectrolyte additives for breaking stable emulsions and suspensions.

Electrocoagulation generally avoids the use of chemicals and secondary pollution caused by the addition of chemical substances and has the added advantage of removing the smallest colloidal particles by flocculating them into larger particles subject to gravity and prior art methods of filtration.

Direct current is used to produce various electrochemical reactions. Electrolysis creates small particles which then become the centres for larger stable, insoluble complex metal ions. Halogen complexing causes metal ions to bind to chlorine ions thus separating pesticides et cetera from water.

Electricity-based coagulation removes contaminants which are generally more difficult to remove by filtration or chemical treatment systems such as emulsified oil, refractory organics, total petroleum hydrocarbons, suspended solids and heavy metals. After the coagulation process, a variety of different removal methods may be used including settlement followed by decantation of the clear liquid and also filtration and sedimentation to remove the enlarged particles from the flow of effluent. Because the size of the coagulated particles is much greater than those in the untreated flow, they are much easier to dispose of. Filters become much more effective since filter membranes are not blocked by very fine particles such as colloids and can be cleaned more easily by back-flushing.

According to a known method of electrocoagulation, a reactor is made up of an electrolytic cell with one anode and one cathode. When connected to an external power source, the anode material will electrochemically corrode due to oxidation, while the cathode will be subjected to passivation. During electrolysis, the positive side undergoes anodic reactions, while on the negative side, cathodic reactions are encountered. Consumable metal plates, such as iron or aluminum, are usually used as sacrificial electrodes to continuously produce ions in the water. The released ions neutralize the charges of the particles and thereby initiate coagulation. The released ions remove undesirable contaminants either by chemical reaction and precipitation, or by causing the colloidal materials to coalesce, which can then be removed by flotation. In addition, as water containing colloidal particulates, oils, or other contaminants move through the applied electric field, there may be ionization, electrolysis, hydrolysis, and free-radical formation which can alter the physical and chemical properties of water and contaminants. As a result, the reactive and excited state causes contaminants to be released from the water and destroyed or made less soluble. Examples of such prior methods of electrocoagulation using anodes and cathodes with an external power source are described, for example at:
https://en.wikipedia.org/wiki/Electrocoagulation;
http://www.gerberpumps.com/electrocoagulation-technology.html

There exists a problem to provide for removing of suspended materials from fluids by coagulation that avoids the disadvantages of the known techniques described above.

### SUMMARY

The presently claimed subject matter is defined in the claims.

An example method to coagulate suspended particles in a flowing fluid flowing in pipework comprises:
providing a first electrical connection for electrically connecting to ground an electrically conductive surface in contact with the flowing fluid at a first location in the pipework and a second electrical connection for electrically connecting the flowing fluid to ground at a second location in the pipework, wherein at least one control impedance to control a potential difference to ground is included in at least one of the first and second electrical connections;
providing a device in the pipework, the device including at least one dielectric flow channel for the fluid to flow in a flow direction from upstream to downstream through the at least one dielectric flow channel, each dielectric flow channel configured such that surfaces of the dielectric flow channel in contact with the fluid flowing through the at least one dielectric flow channel are at a third location between the first location and the second location in the pipework and are formed of a dielectric material having a negative charge affinity; and
using the at least one control impedance to control an impressed current in the fluid caused by the fluid flowing over the surfaces of the at least one dielectric flow channel and to cause suspended particles in the fluid to be charged, wherein the charge of the suspended particles is caused to be neutralised at the second electrical connector causing coagulation of the particles as suspended insoluble particles.

An example apparatus comprises:
pipework for containing a flowing fluid containing suspended particles;
a first electrical connection for electrically connecting to ground an electrically conductive surface in contact with the fluid at a first location in the pipework,
a second electrical connection for electrically connecting the fluid to ground at a second location in the pipework, wherein the second electrical connection comprises at least one electrically conductive component in contact with the fluid at the second location;
at least one control impedance to control a potential difference to ground in at least one of the first and second electrical connections; and
a device in the pipework, the device including at least one dielectric flow channel for the fluid to flow in a flow direction from upstream to downstream through the at least one dielectric flow channel, the at least one each dielectric flow channel being configured such that a surface of the dielectric flow channel in contact with the fluid flowing through the dielectric flow channel is at a third location between the first location and the second location and is formed of a dielectric material having a negative charge affinity, wherein
the at least one control impedance is configured to control an impressed current in the fluid caused by the fluid flowing over the surfaces of the at least one dielectric flow channel and to cause suspended particles in the fluid to be charged, and the second electrical connector is configured to neutralise the charge of the suspended particles causing coagulation of suspended insoluble particles.

An example system comprises such an apparatus wherein:
the first electrical connection electrically connects to ground an electrically conductive surface in contact with the fluid at the first location in the pipework and the second electrical connection at the second location electrically connects the fluid to ground,
the at least one control impedance is configured to control a potential difference to ground is included in at least one of the first and second electrical connections; and
the device is provided in the pipework or channel and includes the at least one dielectric flow channel for the fluid to flow in a flow direction from upstream to downstream through the at least one dielectric flow channel, wherein the at least one dielectric flow channel in contact with the fluid flowing through the dielectric flow channel is at the third location between the first location and the second location and is formed of a dielectric material having a negative charge affinity, the at least one control impedance being configured to control an impressed current in the fluid caused by the fluid flowing over the surfaces of the at least one dielectric flow channel and to cause suspended particles in the fluid to be charged, and the second electrical connection is configured to neutralise the charge of the suspended particles causing coagulation of the particles as suspended insoluble particles;
the system further comprising means for removing the suspended insoluble particles from the fluid.

The dielectric material having a negative charge affinity causes a resulting positive charge to be impressed on particles, ions and compounds in the liquid that can then travel downstream and contact the surfaces of the second electrical connection where their charge is neutralised and the particles are caused to flocculate and settle and become large enough to remove from the fluid via, for example, a filtration or decantation process.

As a result, a method and apparatus as claimed herein offers considerable technical and practical benefits over existing electrocoagulation methods of removing suspended material from fluids through the use of an internal source of power. Whereas prior art electrolytic methods described above create products in the fluid by using consumable electrodes, a method and apparatus as claimed herein uses electrostatic charge generated by the passage of an electrolyte across the surface of a dielectric material having a negative charge affinity to positively charge insoluble particles in the flowing fluid. This process does not add to the total solids present in the flowing fluid as does a consumable electrode. The passage of an electrolyte across the surface of a dielectric material having a negative charge affinity adds charge to the insoluble suspended particles which are then carried downstream where they become neutralized by contact with an earthed conductive surface. Upon losing their charge and becoming neutralised they coagulate to form much larger particles which can be removed by one of many prior art methods.

### BRIEF DESCRIPTION OF THE DRAWINGS

Example embodiments are described with reference to the drawings in which:

FIGS. 1A and 1B form a schematic representation of a first example of a system and apparatus;

FIGS. 2A, 2B and 2C are a side view, an end view and a cross-sectional view, respectively, of an example of a device for the system and apparatus of FIG. 1;

FIGS. 3A and 3B is a part cross-sectional view and a perspective view, respectively, of a component of the device 2A, 2B, and 2C; and

FIG. 4 is a schematic representation of an alternative configuration of part of the system and apparatus of FIG. 1.

### DETAILED DESCRIPTION

In an example embodiment, a system comprises an apparatus that includes a device which presents a surface of a dielectric material to a flowing or circulating fluid, for example a liquid such as water. The device can be constructed of or comprise dielectric or electrically insulating material so as to electrically isolate pipework upstream of the device from pipework downstream of the device (apart from via an electrolytic fluid passing through the device). In an example installation, fluid flows through the device and the fluid is connected upstream of the device to earth by means of a first electrical connection and is connected to earth downstream of the device by means of a second electrical connection. The first electrical connection may be physically connected to the upstream end of the device. The first and second connections are both connected to earth for grounding the fluid at those locations. Either or both of the first and second connections includes a control impedance. Either or both connections to earth contain means for measuring and controlling, for example, by means of an ammeter, voltmeter and variable impedance (e.g., a variable resistor) a flow of current to and from the electrical connections. As a result of the fluid flowing across the dielectric, charge can be created at a boundary layer of the dielectric where it contacts the fluid. The charge can be transported to the second electrical connection by one or both of ion exchange and the charging of compounds, for example insoluble dielectric particles such as colloids, in the flowing electrolyte, whereby an impressed electrical current is created without the use of an externally applied DC or other power source.

It should be understood that the terms “pipework” and “pipe” are used herein in a general context and the pipework need not be formed from closed cross-section pipes and that the “pipework” and the “pipes” could comprise, at least in part, open channels or the like.

The process by which charge can be created can be explained by the Electro-Kinetic Potential (sometime known as the streaming Zeta Potential), which results in a streaming electric current as an electrolyte passes through a channel with charged walls. The effective charge of different materials differs as a result of the TriboElectric effect that results when different materials come into contact (see, for example, http://en.wikipedia.org/wiki/triboelectric effect and http://www.trifield.com/content/tribo-electric-series/). When two different materials are in contact with each other the surface of one material can steal some electrons from the surface of the other material. The material that steals electrons has the stronger affinity for negative charge of the two materials, and that surface will be negatively charged after the materials are separated with the other material having an equal amount of positive charge. If various insulating materials are contacted and the amount and polarity of the charge on each surface is separately measured, a resulting pattern of charge results that is represented in the so-called TriboElectric series.

For example, where a device presenting an appropriate surface area of dielectric to a fluid flowing through the device, the flowing electrolytic fluid can be electrically connected to earth at a location upstream of the device and the flowing electrolytic fluid can be connected to earth downstream of the device with the electrolytic fluid flowing between the device and the downstream location via insulating pipework (for example of dielectric material such as acrylonitrile butadiene styrene (ABS), polyvinyl chloride (PVC), or polypropylene). This therefore provides an electrical circuit including the path via a conductive fluid flowing from the upstream location, via the device and the insulating pipework to the downstream location. An impressed current created at the boundary layer between the dielectric and the flowing fluid can provide electrical charging of insoluble particles within the fluid flowing from the first location, via the device and the insulating pipework to the second location. The electrically charged particles then lose their charge to earth at the second location as a result of the second electrical connection to earth, become electrically neutral and flocculate/coagulate into larger particles which are dense enough to settle through gravitational effects and may be removed from the fluid. Examples of means for removing the coagulated insoluble particles include decantation of the clean fluid and filtration.

The second electrical connection to earth can include, for example, an earthed apparatus with a large surface area in contact with the flowing electrolyte to enable a greater efficiency of charge neutralisation of the suspended particles.

Where the first location of the first earth connection is upstream of the device, at least a section of pipework further upstream with respect to the first location can be constructed of a dielectric material such as ABS, PVC or polypropylene. This can facilitate measurement and control of the impressed current. Electrical contact with the fluid at the first location with respect to the distal end of the device can be achieved, for example, using a non-corrodible material such as a section of pipe constructed from ferrosilicon (otherwise known as silicon iron). Ferrosilicon is an alloy of iron and silicon with average silicon content between 15 and 90 percent weight. It contains a high proportion of iron silicides. Connecting the location with respect to the distal end of the device via earth avoids the possibility of high voltages presenting a hazard.

A connection to earth provides a neutral connection, behaving as an anode if it receives electrons and a cathode if it loses electrons. A controllable, focused and measurable direct current potential between the first and second connections can be provided to facilitate the coagulation and precipitation of the suspended insoluble material within the flowing fluid. No external DC source is necessary. Means can be provided for measuring, adjusting and controlling a current impressed on the particles in suspension in the flowing fluid and subsequent coagulation of suspended insoluble particles, for example in the form of one or more of an ammeter, voltmeter and variable impedance (e.g., a variable resistor).

A dielectric that has an affinity to negative charge can produce a flow of positively charged particles in the fluid downstream of the dielectric as positive charge attaches to ions and insoluble particles in an electrolyte flowing across the boundary layer of the dielectric. This flow of positive charge downstream of the dielectric is allowed to neutralise at the second connection. One example relates to the removal of insoluble material from a flowing fluid electrolyte effluent from for instance a mining works which gives rise to excessive amounts of metallic oxides and other compounds being carried into water courses where they can damage the environment. A further example application can relate to removing the ‘bloom’ of suspended colloidal particles from drinking water supplies and enabling greater efficiency of filtration methods by coagulating the colloids into larger and more easily filtered particles.

To enhance the effectiveness of the impressed current, the device can be configured to create turbulent flow or cavitation within the device and in contact with the dielectric. The cavitation can cause local changes in pressure in the fluid, which in turn enhances the precipitation of dissolved solids and the coagulation of particles in the fluid.

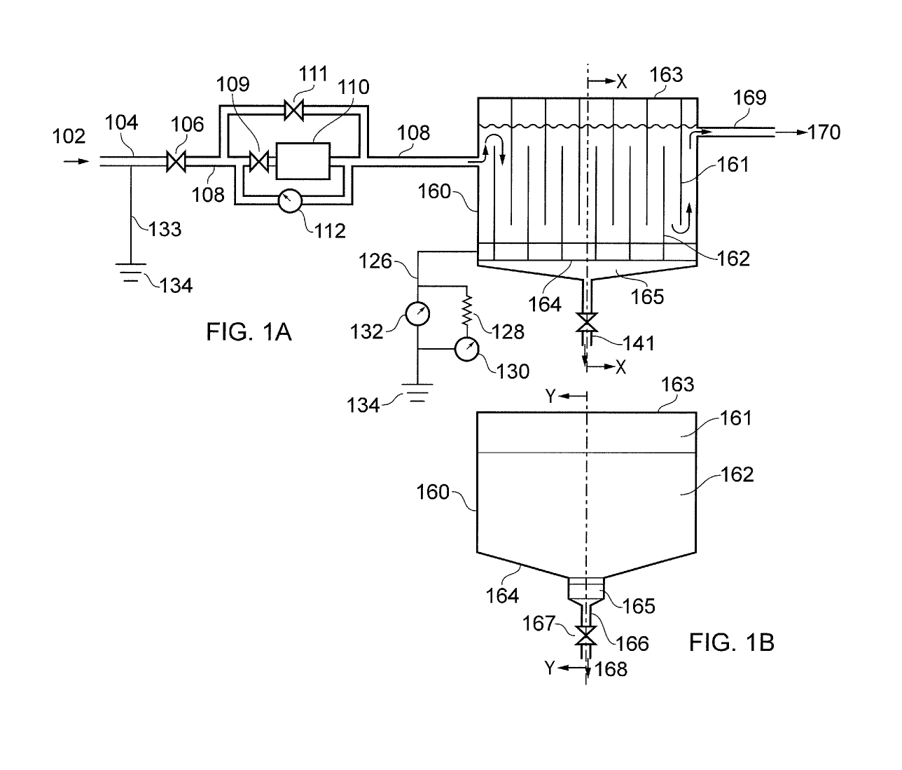

FIGS. 1A and 1B form a schematic representation of an embodiment of the claimed subject matter for the treatment of effluent water. It is to be understood in other embodiments other fluids can be treated. FIG. 1B is a cross section at X-X in FIG. 1A, and a tank 160 on FIG. 1A is shown as a cross section at Y-Y in FIG. 1B.

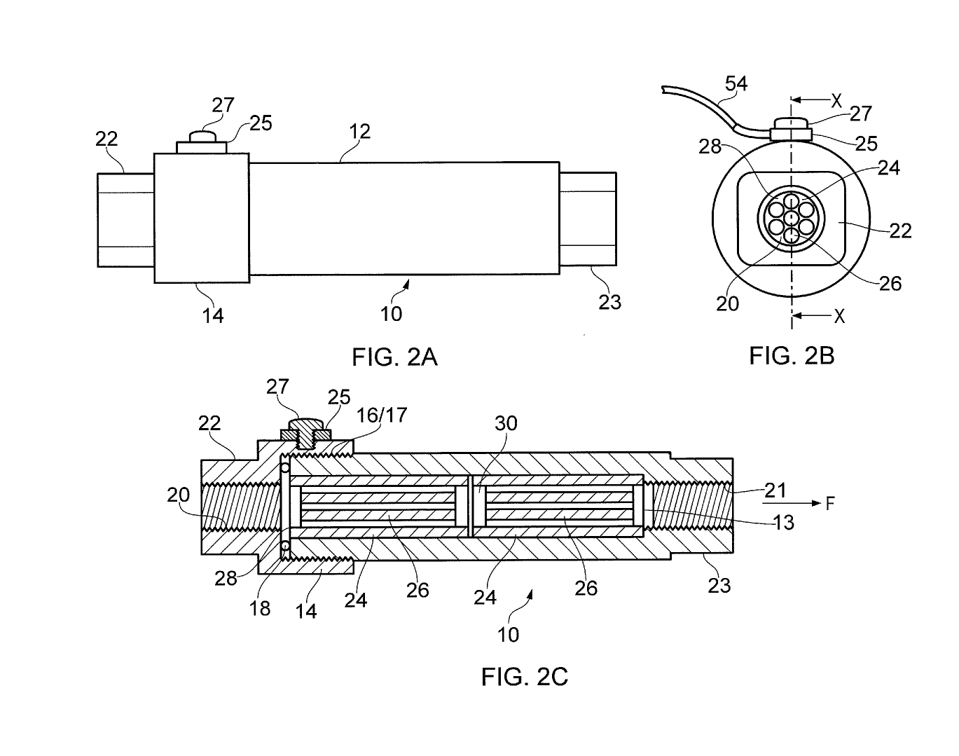

In FIG. 1A, effluent water 102 is caused to flow from a stop valve (e.g. a tap) 106 via plastics pipework 108 (for example of ABS, PVC or polypropylene). A device 110 comprising dielectric material that has an electronegative potential (i.e., it has an affinity to negative charge and tends to charge to negative) according to the TriboElectric Series (see http://www.trifield.com/content/tribo-electric-series), exposes a large surface area of the dielectric to the flowing water and is incorporated into the pipe upstream of the device. In an example implementation, the dielectric material is polytetrafluoroethylene (PTFE), as this has a significant electronegative potential among dielectrics. The device 110 can be a device as described with respect to FIGS. 2A, 2B and 2C. Although PTFE is used in this embodiment, other dielectric materials having an electronegative potential could be used.

The pipe 108 is allowed to discharge water into a tank 160 insulated from the ground on insulating (e.g., plastics) supports (not shown) in which a series of alternating baffles 161, 162 are incorporated. The baffles 161, 162 are configured to provide a tortuous path though which the water flows, thereby providing a very large surface area of the water in contact with the surface of the baffles 161, 162. The baffles 161, 162 can be formed of an electrically conductive material, for example a metal, for example steel, stainless steel, copper etc. The tank can be made of an electrically insulating material or can be made of an electrically conducting material, for example a metal. The metal can be any suitable metal such as steel, stainless steel, copper, etc. An overflow, decantation, outlet 169 is arranged at the top of the tank 160 to allow treated water 170 to flow for onward handling and filtration. The pipe 104 upstream of the stop valve 106 (and accordingly also upstream of the device 110) can be a metal pipe that is earthed (grounded) 134 via a ground connection 133. The section of the pipe 104 that is earthed is preferably a metal that is resistant to corrosion, for example brass or ferrosilicon. The baffles 161 and the tank 160 (if made of electrically conductive material) are earthed (grounded) 134 by means of an electrical connection 126 which incorporates means to measure both potential difference (PD) (e.g., voltmeter 132) and current flow (e.g., ammeter 130) and via a variable impedance 128, for example a variable resistance. In the example shown, the tank is made of an electrically conductive material and includes baffles 161 that are connected to the top 163 of the tank 160 and baffles 162 that are connected to the bottom 164 of the tank 160, whereby the baffles 161 and 162 are earthed via the electrical connection 126 to the tank 160. Accordingly, an electrical circuit is established, when water is flowing as a constant stream from the pipework 108 into the tank 160. This electrical circuit includes the flowing water (which forms an electrolyte), the earthed (ground) connection 126 to the tank 160 and baffles 161 and 162 and the earthed (grounded) water supply pipe 104 upstream of the stop valve 106. It should be noted that the upstream end of a device 110 (if provided with a metal upstream end connector as shown in FIGS. 2A to 2C) could also be connected to earth via a grounding connection (not shown).

The flowing water interacts with the device 110, which acts as a dielectric charge generator without the need for a battery or external electrical source. The variable resistance 128 can be used to control the potential difference between the tank 160 and its baffles 161 and 162 and earth.

A bypass for the dielectric device 110 is provided using a section of insulating pipe of a plastics material and a shut-off valve 111 of a plastics material in combination with a shut off valve 109 of a plastics material upstream of the device 110 to enable a comparison of operation with and without the use of the device 110. The pressure drop across the device 110 can be measured using a pressure drop gauge 112. As water flows into the tank via the device 110, the potential between the tank, the baffles and earth is controlled according to the setting of the variable impedance and how much current flows to/from earth is facilitated. The described arrangement allows testing of the relationships between rate of flow of water, surface area and type of dielectric, volume of water in the tank, PD and resistance and measurement of the degree of coagulation of suspended particles in the flowing liquid. Bypassing the device 110 enables control data to be established.

The arrangement described with reference to FIG. 1A is such that a direct electrical connection across the dielectric assembly 110 is avoided, as this would reduce its effectiveness in providing an impressed charge/current to drive the electrolytic cell. For instance, if the dielectric material of the device 110 were housed in a metal case that is also in contact with the flowing fluid upstream and downstream of the device, then this would effectively “short” the device. FIG. 1A is a schematic diagram of an application of the claimed subject matter to either unpotable water flowing as an environmentally toxic effluent from a chemical treatment plant for continued treatment to remove impurities or to sewage treatment effluent after its biochemical treatment and requiring only final treatment by filtration to remove suspended colloids.

In the example shown in FIG. 1A, the charge on the suspended particles in the fluid will be neutralised as the fluid contacts the baffles 161 and 162, and the particles will coagulate to form suspended insoluble particles of a size such that the particles fall under gravity to the bottom of the tank 160. In an advantageous embodiment, the surface area of the baffles 161 and 162 in contact with the water in the tank 160 is chosen to be significantly larger than the surface area of the dielectric in contact with the water in the device 110, for example at least twice as large, for example at least ten times, for example one hundred times or even larger. This enhances the neutralisation effect of the second electrical connection that includes the baffles 161, 162 on the charged particles in the water. This also means that the flow rate of the water over the surfaces of the second electrical connection in contact with the water can be significantly less than the flow rate of the water through the device 110, thereby facilitating the deposition of the particles in the water.

The particles can then be removed in any suitable manner, for example by regularly purging or cleaning the tank, or by using a removable filter system.

For example, as shown in FIG. 1B, the bottom 164 of the tank 160 can be arranged to slope downwards towards a central gully 165, (not shown) towards a discharge outlet 166 that includes a purge valve 167 to facilitate removal at 168 of the particles that fall under gravity to the bottom of the tank 160.

In the example shown in FIG. 1, the cleaned water can be removed by “decanting” the cleaned water at the top of the tank 160 via the outflow 169, with the coagulated particles being removed at the bottom of the tank via the discharge outlet 166.

In other example embodiments, other more complex arrangements can be used to separate the cleaned water from the coagulated particles, including, for example a centrifugal water filter or a belt filter as will be apparent to a person skilled in the art.

FIGS. 2A, 2B and 2C are schematic illustrations of an example of a device 110 for use as the device 110 of FIG. 1.

FIG. 2A is a side view of the example device 110. It comprises a generally cylindrical body, or housing, 12, which is, for example, formed of an electrically insulating material, e.g., a plastics material such as ABS, PVC or polypropylene. At one end of the cylindrical housing 12, an end cap 14 is provided. In one example, the end cap 14 can be made of a plastics material, for example ABS, PVC or polypropylene. In the example shown in FIG. 2B, the end cap 14 is made of a conductive material, such as brass or ferrosilicon.

The end cap comprises a connector 25 that is mechanically and electrically connected to a wire 54 for forming an electrical connection such as the electrical connection 133, the example installations shown in FIG. 1. A screw or bolt 27 that engages with a threaded hole in the end cap provides a mechanical and electrical connection between the connector 25 and the end cap 14. As an alternative to a screw, the connector 25 can be connected to the end cap using one or more of a clamp, a worm drive clip or band, hose clip or band.

FIG. 2B shows an end view of the device of FIG. 2A.

FIG. 2C shows the end of the end cap 14 with a boss 22 formed with flat surfaces to assist in turning the end cap for attachment of the end cap to the body 12 as will be described hereinafter, and for connecting the device to a co-operating coupling on an adjoining piece of pipework. The boss 22 is formed with an internal thread 20 for connecting to such a coupling on the adjoining pipework.

FIG. 2C is a cross sectional view through the device of FIGS. 2A and 2B taken along the line X--X in FIG. 2B. As viewed in FIG. 2C, it can be seen that the end cap 14 is additionally provided with an internal screw thread 16 for co-operating with a thread 17 provided on the exterior of the body 12 to enable the end cap to be removably screwed onto the body 12. The removability of the end cap facilitates the changing of a dielectric channel-defining component should this become clogged with debris, for example. An O-ring seal 18 is provided to provide good sealing engagement between the end cap and the body 12.

At the other end of the device 10, the body 12 is shaped to form an equivalent boss 23 formed with flat surfaces to assist in connecting the device to a co-operating coupling on an adjoining piece of pipework. The boss 23 is formed with an internal thread 21 for connecting to such a coupling on the adjoining pipework. Located within the housing 12 are, in the present example, two dielectric channel defining components 24. Each dielectric channel-defining component 24 is made of a solid block of dielectric material, for example plastics material, and is formed with a plurality of bores defining separate channels 26. In one example, the dielectric material is PTFE. In use, water 10 (or another fluid as mentioned above), flowing along the pipework is caused to separate and flow along the separate channels from an upstream to a downstream end face 28 of the dielectric channel-defining component 24 in a flow direction F (e.g., from left to right as viewed in FIG. 2C). The external cross-sectional shape of the dielectric channel-defining components 24 is configured to fit within the passage, or cavity 13 formed by the interior wall of the body 12. The end faces of the dielectric channel-defining components 24 are concave (e.g., with a recessed, conical or dished shape), such that when two dielectric channel-defining components 24 are placed one after the other, a chamber 30 is defined between those members, which chamber encourages turbulent motion and cavitation of the water passing through the device and the mixing of the water from respective channels 26.

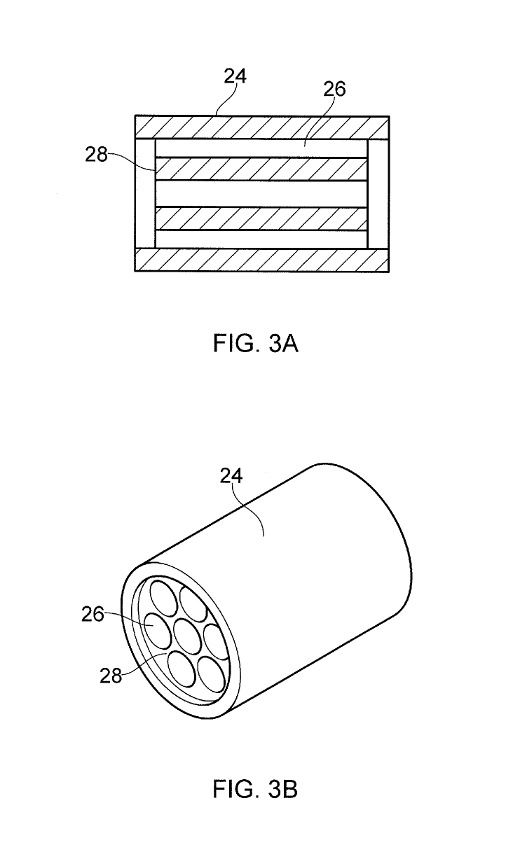

In the example shown (see FIGS. 3A and 3B) the dielectric channel-defining components are generally cylindrical in shape and are formed of a solid block of material with a plurality of small channels 26 passing through the length thereof. In the example shown, each of the end faces 28 is recessed. In other examples, however, the end faces need not be recessed. Alternatively, one end face may be recessed where it is intended to abut against a corresponding recessed face of an adjacent dielectric channel-defining component in order to define a turbulence chamber as described with reference to FIG. 2C.

It will be appreciated that the above described embodiments are by way of example only. Although the examples are described in the context of removing particles from effluent water, it will be appreciated that the claimed subject matter is applicable to the removal of particles from other fluids that behave as an electrolyte.

Also, although a particular form for the system shown in FIG. 1 and the device shown in FIGS. 2 and 3 is shown, the system and the device could take other forms.

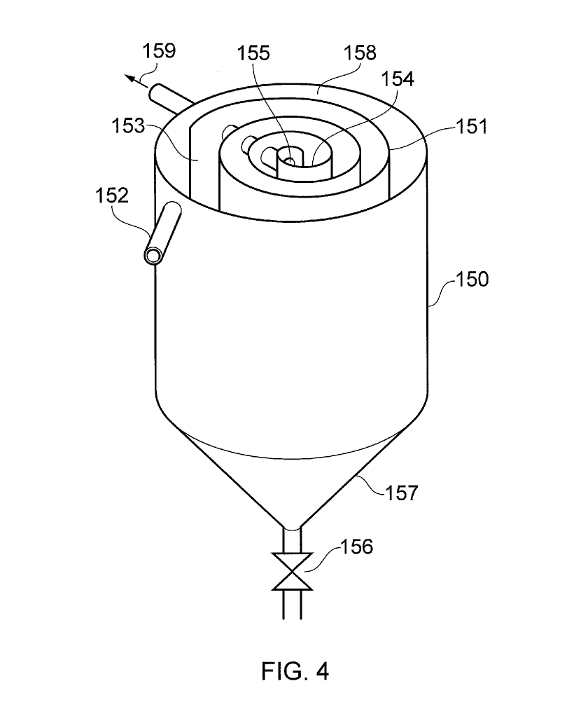

For example, rather that a rectangular tank 160 with baffles 161, 162 as shown in FIGS. 1A and 1B, the tank could take other forms, for example the form of a cylindrical tank 150 as shown in FIG. 4. FIG. 4 is a schematic representation of a cylindrical tank 150 with a top of the tank removed. As shown in FIG. 4, the tank 150 has a baffle 151 arranged as a spiral about a vertical axis. In such a configuration, the fluid being treated could enter through a pipe 152 at, for example, an outer turn 153 of the spiral baffle 151 and be caused to flow spirally inwardly towards an inner turn 154 of the baffle 151, whereby the treated and cleaned fluid could be flow out from an upper part 155 of an inner turn 154 of the spiral baffle to an treated fluid outlet 159. Coagulated particles could be collected at a purge valve 156 at a lower end of a conical bottom surface 157 of the tank 150. In the example shown in FIG. 4, the outer wall 158 of the tank 150 extends above the inlet pipe 152, the spiral baffle 151 and the outlet 159 for the treated fluid. As shown in the example in FIG. 4, the spiral 151 is shown with a limited number of turns for ease of illustration. In other examples, the spiral baffle 151 could include more turns to increase the available surface area of the baffle 151 in contact with the fluid flowing over the baffle 151.

In the example shown, the downstream, second electrical connection includes baffles in a tank.

However, in other examples, other configurations can be provided that include a large electrically conductive area in contact with the fluid, for example, by means of a electrically conductive tank without baffles, a pipeline or channel (e.g. of an electrically conductive metal), or a reservoir with an electrically conductive surface in contact with the water or other fluid being treated.

1. A method for coagulating suspended particles in a flowing fluid flowing in pipework comprises:
providing a first electrical connection for electrically connecting to ground an electrically conductive surface in contact with the flowing fluid at a first location in the pipework and a second electrical connection for electrically connecting the flowing fluid to ground at a second location in the pipework, wherein at least one control impedance to control a potential difference to ground is included in at least one of the first and second electrical connections;
providing a device in the pipework, the device including at least one dielectric flow channel for the fluid to flow in a flow direction from upstream to downstream through the at least one dielectric flow channel, each dielectric flow channel configured such that surfaces of the dielectric flow channel in contact with the fluid flowing through the at least one dielectric flow channel are at a third location between the first location and the second location in the pipework and are formed of a dielectric material having a negative charge affinity; and
using the at least one control impedance to control an impressed current in the fluid caused by the fluid flowing over the surfaces of the at least one dielectric flow channel and to cause suspended particles in the fluid to be charged, wherein the charge of the suspended particles is caused to be neutralised at the second electrical connector causing coagulation of suspended insoluble particles.

2. The method of claim 1, wherein the dielectric material causes a charge to be impressed on suspended particles in the flowing fluid.

3. The method of claim 1, wherein the first electrical connection is electrically insulated from the second electrical connection apart from via the fluid in the pipework and the respective connections to ground.

4-8. (canceled)

9. The method of claim 1 comprising causing at least one of turbulence or cavitation in the fluid passing through the at least one dielectric channel.

10. The method of claim 1, wherein the second electrical connection for electrically connecting the flowing fluid to ground at a second location in the pipework can comprises one or more of at least one electrically conductive baffle, tanks, pipeline, channel, or reservoir.

11. The method of claim 1, wherein the second electrical connection provides a surface area in contact with the fluid greater than the surface area of the surfaces of the dielectric flow channel in contact with the fluid.

12-13. (canceled)

14. An apparatus comprising:
pipework for containing a flowing fluid containing suspended particles;
a first electrical connection for electrically connecting to ground an electrically conductive surface in contact with the fluid at a first location in the pipework,
a second electrical connection for electrically connecting the fluid to ground at a second location in the pipework, wherein the second electrical connection comprises an electrically conductive component in contact with the fluid at the second location;
at least one control impedance to control a potential difference to ground in at least one of the first and second electrical connections; and
a device in the pipework, the device including at least one dielectric flow channel for the fluid to flow in a flow direction from upstream to downstream through the at least one dielectric flow channel, the at least one each dielectric flow channel being configured such that a surface of the dielectric flow channel in contact with the fluid flowing through the dielectric flow channel is at a third location between the first location and the second location and is formed of a dielectric material having a negative charge affinity, wherein
the at least one control impedance is configured to control an impressed current in the fluid caused by the fluid flowing over the surfaces of the at least one dielectric flow channel and to cause suspended particles in the fluid to be charged, and the second electrical connector is configured to neutralise the charge of the suspended particles causing coagulation of suspended insoluble particles.

15. (canceled)

16. The apparatus of claim 14, wherein the device comprises:
an enclosure defining a cavity that extends between an inlet and an outlet for fluid to flow in a flow direction;
at least one dielectric channel-defining component located in said cavity between said inlet and said outlet and extending at least part way along said cavity in the direction of flow from said inlet to said outlet, said dielectric channel defining element dividing said cavity into a plurality of dielectric flow channels that are mutually coextensive for at least part of their length in said flow direction and are each bounded by dielectric material; and a fitment at a first end of the cavity for retaining said at least one dielectric channel-defining component in the cavity.

17. The apparatus of claim 16, wherein the device comprises said at least one electrically conductive surface in contact with the fluid at the first location in the pipework.

18. The apparatus of claim 17, wherein the fitment at an end of the cavity comprises said electrically conductive surface in contact with the fluid at the first location in the pipework.

19. The apparatus of claim 18, wherein the fitment forms a connector for mechanically connecting the device to pipework at the first end of the device, the fitment comprising a corrosion-resistant metal providing said electrically conductive surface to be in contact with the fluid at the first location and comprising means for attaching an electrical connection to ground.

20. The apparatus of claim 14, wherein said at least one electrically conductive surface at the first location is separate from the device.

21. The apparatus of claim 16, wherein the device further comprising a plurality of said dielectric channel-defining components located in said cavity between inlet and said outlet, each said dielectric channel-defining component extending part way along said cavity in the direction of flow from said inlet to said outlet.

22. The apparatus of claim 21, wherein respective ones of said dielectric channel defining components extend over respective parts of said cavity in the direction of flow from said inlet to said outlet and have opposed end faces configured to define a turbulence chamber therebetween.

23. The apparatus of claim 16, wherein a said dielectric channel defining component comprises a block of dielectric material having a cross-section to fit within said cavity, said block of dielectric material being formed with a plurality of channels extending in said direction of flow, each channel-defining a respective one of said dielectric flow channels.

24. (canceled)

25. The apparatus of claim 16, wherein a said dielectric channel defining component comprises an elongate dielectric core extending substantially in said flow direction, a plurality of dielectric blades extending outwardly therefrom and a dielectric tubular member configured to fit within said cavity, said tubular member being formed integrally with an outer end of said outwardly extending blades or cooperating with said outer end of said outwardly extending blades to define a plurality of said dielectric flow channels about said core.

26. The apparatus of claim 16, wherein the enclosure defining a cavity comprises a dielectric surface to the cavity that extends between an inlet and an outlet for fluid to flow in a flow direction.

27. (canceled)

28. The apparatus of claim 16, wherein the enclosure comprises an integral connection at a second end of the device, the integral connection configured for connecting the device to pipework at the second end of the device.

29. The apparatus of claim 16, comprising a second fitment at a second end of the device opposite to the first end of the device, the second fitment configured for connecting the device to pipework at the second end of the device.

30. (canceled)

31. A system comprising the apparatus of claim 14, wherein:
the first electrical connection electrically connects to ground an electrically conductive surface in contact with the fluid at the first location in the pipework and the second electrical connection at the second location electrically connects the fluid to ground,
the at least one control impedance is configured to control a potential difference to ground is included in at least one of the first and second electrical connections; and
the device is provided in the pipework or channel and includes the at least one dielectric flow channel for the fluid to flow in a flow direction from upstream to downstream through the at least one dielectric flow channel, wherein the at least one dielectric flow channel in contact with the fluid flowing through the dielectric flow channel is at the third location between the first location and the second location and is formed of a dielectric material having a negative charge affinity, the at least one control impedance being configured to control an impressed current in the fluid caused by the fluid flowing over the surfaces of the at least one dielectric flow channel and to cause suspended particles in the fluid to be charged, and the second electrical connection is configured to neutralise the charge of the suspended particles causing coagulation of the particles as suspended insoluble particles; and
the system further comprising means for removing the suspended insoluble particles from the fluid.

32-39. (canceled)
